(19) United States
(12) Patent Application Publication
(10) Pub. No.: US 2016/0315511 A1
(43) Pub. Date: Oct. 27, 2016

(54) MAGNETIC FLUX MOTOR

(71) Applicant: Apple Inc., Cupertino, CA (US)

(72) Inventors: Tommaso P. Rivellini, Cupertino, CA (US); Storrs T. Hoen, Cupertino, CA (US); Christof Zwyssig, Jona (CH); Andreas Looser, Zurich (CH); Daniel Krähenbühl, Munsingen (CH); Thomas Ivar Baumgartner, Zurich (CH); Samuel Jakob Stauber, Gelterkinden (CH)

(21) Appl. No.: 15/047,919

(22) Filed: Feb. 19, 2016

Related U.S. Application Data
(60) Provisional application No. 62/151,338, filed on Apr. 22, 2015.

(51) Int. Cl. H02K 1/27; H02K 7/06

(52) U.S. Cl. CPC H02K 1/27; H02K 7/063

(57) ABSTRACT

One or more embodiments may take the form of a motor having a magnetically-driven mass. In certain embodiments, the mass or masses may be rotated about a connected shaft through axial or radial magnetic flux. Generally, embodiments described herein employ radial or axial magnetic flux to turn one or more magnets affixed to a central shaft, thereby rotating the shaft through the magnet(s') motion to produce a desired output or effect.

### CROSS-REFERENCE TO RELATED APPLICATION(S)

This application is a nonprovisional patent application of and claims the benefit of U.S. Provisional Patent Application No. 62/151,338, filed Apr. 22, 2015 and titled “Magnetic Flux Motor,” the disclosure of which is hereby incorporated herein by reference in its entirety.

### FIELD

Embodiments described herein may take the form of motors, and more particularly may take the form of magnetic motors in which motion is imparted through magnetic flux.

### BACKGROUND

Electronic devices, such as mobile phones, tablet computing devices, media players, laptop computers, and so on, may employ motors for a variety of tasks. As one example, some mobile phones use a motor to vibrate the phone in response to an incoming call. As another example, an electronic device may use a motor to provide a tactile output, such as a vibratory pattern, in response to a user's input or operating state of the device. As still another example, some electronic devices may use motors to move the device.

As electronic devices continue to decrease in size, space within the device becomes increasingly valuable. Further, users generally expect increased battery life with any iteration of an electronic device, even if the device becomes smaller. Thus, batteries typically occupy a significant portion of the interior of an electronic device and leave little room for other components.

Further, many electronic device manufacturers attempt to make their products as slim as possible. This reduction in thickness means that any component inside the device must also become thinner in order to fit.

Accordingly, there is a need for an improved motor design suitable for use with small form-factor electronic devices.

### SUMMARY

Generally, embodiments described herein take the form of a magnetic flux motor. One embodiment may take the form of an apparatus, comprising: a shaft; a mass disposed on the shaft; a stator adjacent the shaft; and a magnet encircling a portion of the shaft; wherein the stator is configured to generate a magnetic flux; the magnet is configured to rotate by operation of the magnetic flux on the magnet; and the stator, mass, and magnet are co-axial with the shaft.

Another embodiment may take the form of a motor, comprising: a shaft; a group of ferritic masses affixed to the shaft; a group of stators equal in number to the group of ferritic masses, each stator adjacent a ferritic mass of the group of ferritic masses; wherein each of the group of stators is operative to generate magnetic flux when energized; each of the group of ferritic masses is operative to rotate perpendicular to a longitudinal axis of the shaft when an adjacent stator is energized, thereby rotating the entire group of ferritic masses and the shaft; the group of ferritic masses and the group of stators are coplanar; and a longitudinal axis of the shaft is coplanar with the group of ferritic masses and the group of stators.

Still another embodiment may take the form of an electronic device, comprising: a display; a housing connected to the display; a motor contained within the housing, the motor comprising: a shaft; a mass affixed to the shaft; a magnetic element encircling the shaft and operative to generate a magnetic field, the magnetic element adjacent the moving mass; wherein the mass moves as the magnetic field varies.

These and other embodiments will become apparent upon reading the specification in its entirety in conjunction with the appended figures.

### BRIEF DESCRIPTION OF THE FIGURES

FIG. 1A depicts a first sample electronic device that may incorporate a magnetic flux motor, as described herein.

FIG. 1B depicts a second sample electronic device that may incorporate a magnetic flux motor, as described herein.

FIG. 1C depicts a third sample electronic device that may incorporate a magnetic flux motor, as described herein.

FIG. 2A depicts an isometric view of a first embodiment of a motor powered by time-varying the energization of one or more stators.

FIG. 2B depicts a simplified, schematic cross-sectional view of the motor of FIG. 2A, taken along line A-A of FIG. 2A and omitting the base structure.

FIG. 3 depicts an isometric view of another sample motor similar to that shown in FIGS. 2A and 2B but having stators positioned on either side of the magnets.

FIG. 4A depicts a first cross-sectional view of a sample axial flux magnetic motor.

FIG. 4B illustrates an isometric view of a sample stator body of the motor of FIG. 4A, showing multiple stators extending therefrom.

FIG. 5 illustrates a cross-section of another embodiment of an axial-flux motor.

FIG. 6A depicts a cross-section of still another embodiment of an axial-flux magnetic motor.

FIG. 6B depicts a cross-section of a central magnetic structure of the motor of FIG. 6A, taken along line 6B-6B of FIG. A.

FIG. 7 illustrates a schematic, cross-sectional view of yet another embodiment of an axial-flux magnetic motor.

FIG. 8 depicts an isometric view of one embodiment of a magnetic reluctance motor.

### DETAILED DESCRIPTION

One or more embodiments may take the form of a motor having a magnetically-driven mass. In certain embodiments, the mass or masses may be rotated about a connected shaft through axial or radial magnetic flux. As used herein, “axial flux” refers to magnetic flux that extends primarily along a longitudinal axis of the aforementioned shaft, which often corresponds to a longitudinal axis of the embodiment. “Radial flux” refers to magnetic flux that extends primarily perpendicular to the longitudinal axis of the shaft.

Some embodiments of a magnetic motor may generate a haptic output, for example for use as a user notification. In other embodiments, the magnetic motor may alter the angle and/or direction of a dropped electronic device. In still other embodiments, the magnetic motor may move the electronic device. Still other functions of the motor will be apparent to those of skill in the art upon reading this disclosure in its entirety.

Generally, embodiments described herein employ radial or axial magnetic flux to turn one or more magnets affixed to a central shaft, thereby rotating the shaft through the magnet(s') motion. Typically, although not necessarily, the magnets are co-axial with the shaft (e.g., a central axis of the shaft and a central axis of the magnet(s) are the same). One or more magnetic elements, such as stators, may be positioned adjacent the magnet or magnets; in certain embodiments, one stator may be positioned next to each magnet. In other embodiments, multiple stators may be positioned adjacent each magnet, for example on diametrically opposing sides of a magnet. In some of these embodiments, each set of stators and magnets may be linearly aligned, thereby reducing the thickness of the motor in at least one direction perpendicular to the longitudinal axis of the shaft and encircling magnets. The stators and magnets are generally aligned in-plane with one another, such that a front face of a magnet or magnets is coplanar with a front face of its associated stators. In other embodiments, a face of a given magnet may be parallel to a face (or faces) of an associated stator (or stators). Still other combinations of magnet and stator placements are possible.

In certain embodiments, each magnet is cylindrical with a top half of the cylinder having a first polarity and a bottom half having a second polarity. Thus, as stators or other magnetic elements adjacent each magnet are energized, magnetic flux will attract a first half of the cylinder magnet and repel the other half. By varying which stator is energized at any given time, or by varying a direction of current through the stator, the embodiment may alter the polarity of the stator, thereby changing which pole of the cylindrical magnet is attracted to the stator (and which is repelled). Through a combination of stator actuation and magnet, the magnets may be rotated about an axis of the shaft, thereby also rotating the shaft and any mass attached to the shaft. Typically, the magnets rotate perpendicular to the plane intersecting the stators and magnets as opposed in in-plane or parallel to such a plane.

In other embodiments, the magnets may have poles situated in a checkerboard pattern, with respect to a cross-section of the magnet, typically taken along the length of the shaft. Multiple magnets may be affixed to one another to create such patterns, as one example. Such embodiments may also be rotated through stator energization to rotate an associated shaft and affixed mass.

Still other embodiments described herein may take the form of a reluctance motor. For example, certain embodiments may position ferritic masses on the shaft instead of magnets. The ferritic masses may be positioned off-center with respect to the shaft or may be non-cylindrical, such that some portions of each ferritic mass extends closer to an associated stator than another portion of the same ferritic mass. Further, each ferritic mass may be rotationally staggered with respect to at least one other ferritic mass.

In this fashion, certain portions of each ferritic mass are attracted to an associated stator when the stator is energized such that it generates a magnetic field. By varying the energization of the stators, different ferritic masses may be attracted at different times, thereby rotating the set of masses. As the ferritic masses rotate, so too does the shaft and any other mass or object attached to the shaft.

These and other embodiments will be more fully described below in conjunction with the figures. Additionally, shading in the cross-sectional views of certain figures indicates like or similar elements, and not necessarily that such commonly-shaded elements are the same or physically connected to one another.

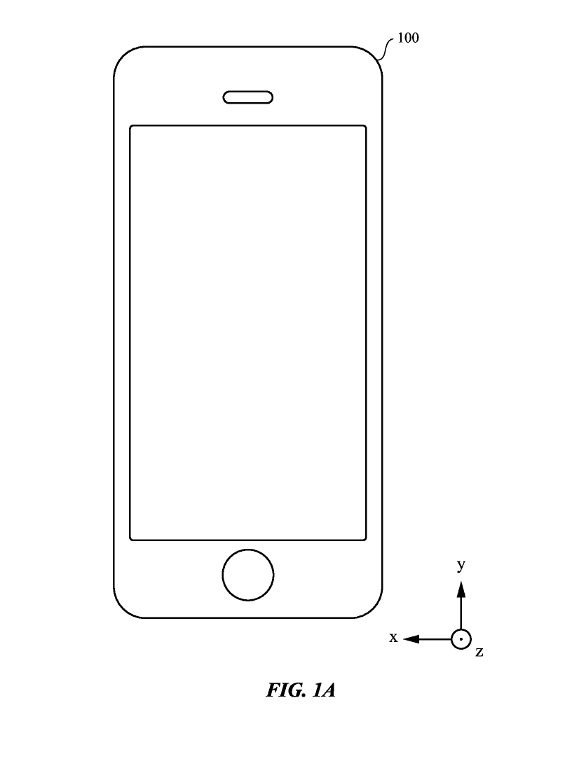

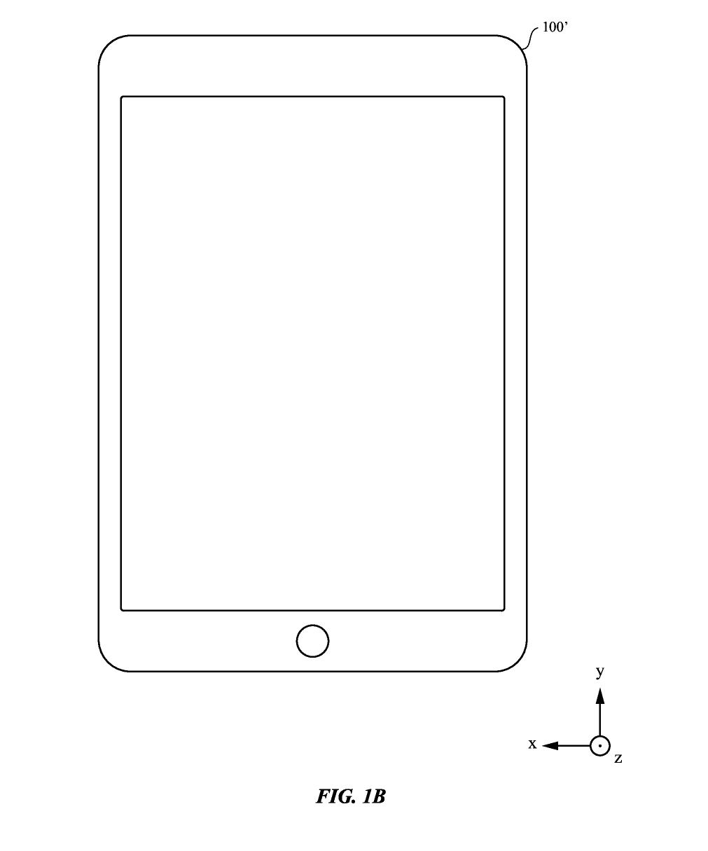

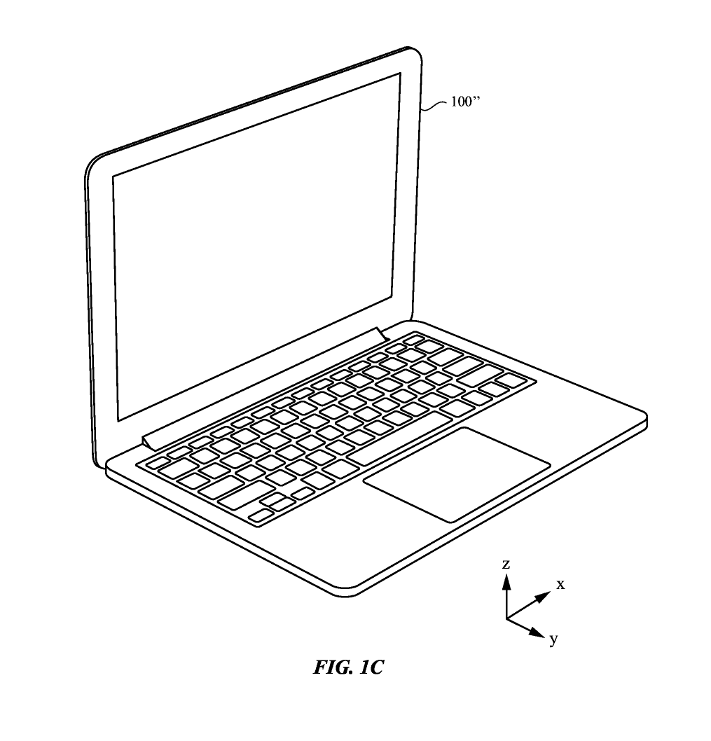

FIGS. 1A-1C depicts various embodiments of an electronic device 100, 100′, 100″ that may incorporate a magnetic motor, as described later herein. The electronic device 100, 100′, 100″ may be any of a number of suitable devices, such as a mobile phone, health monitoring device, wearable (e.g., a watch, glasses, jewelry, armband and the like), tablet computing device, laptop computer, desktop computer, and so on. It should be appreciated that other devices, structures, and apparatuses may also incorporate motors as described herein, and certain embodiments of the motors may be especially suitable for space-constrained conditions such as are often present in small form-factor electronic devices. Reference to an “electronic device 100” is intended to encompass any suitable electronic device listed herein, including those shown in FIGS. 1A-1C.

As one example of incorporation, the height (e.g., the Z-axis as shown in FIGS. 1A-1C) of many electronic devices may be constrained in order to make the devices as thin and/or lightweight as possible. Accordingly, the overall height of a motor incorporated into such an electronic device also may be constrained. However, length and/or width (e.g., the Y- and X-axes as shown in FIGS. 1A-1C) may not be constrained to the same extent as height. Thus, for example, it may be useful to position the magnetic elements (e.g., stators) of a motor such that they are no higher (or only minimally higher) than the height of a largest magnet in combination with a back iron and/or any casing. Generally, certain embodiments may accomplish this by positioning the stator or stators adjacent the magnet or magnets, but not directly above or below the magnets.

One or more motors as described herein may be incorporated into any suitable portion or region of the electronic device 100. The motor's position within the device may vary between embodiment and may vary with the intended function of the motor. In addition, many electronic devices 100 may incorporate multiple motors. In some embodiments, the motors may be electronically coordinated or even physically linked, for example by a common shaft.

The motor may provide functionality to the electronic device 100. For example, many such electronic devices include a display, which may be made from glass, sapphire, or another optically transparent component that is subject to breaking or cracking upon impact, such as from a fall. To prevent such breaking or cracking, the motor may operate to alter a rotation of the electronic device during a fall in order to ensure that a part of the device other than the display impacts the ground or another object.

As another example, motors described herein may provide haptic output to a user touching an electronic device. Operation of the motor may impart vibration or other motion to a housing, display, input element or other part of an electronic device. Thus, as one non-limiting example, the motor may be actuated in response to a user's touch-based input, thereby providing a haptic output.

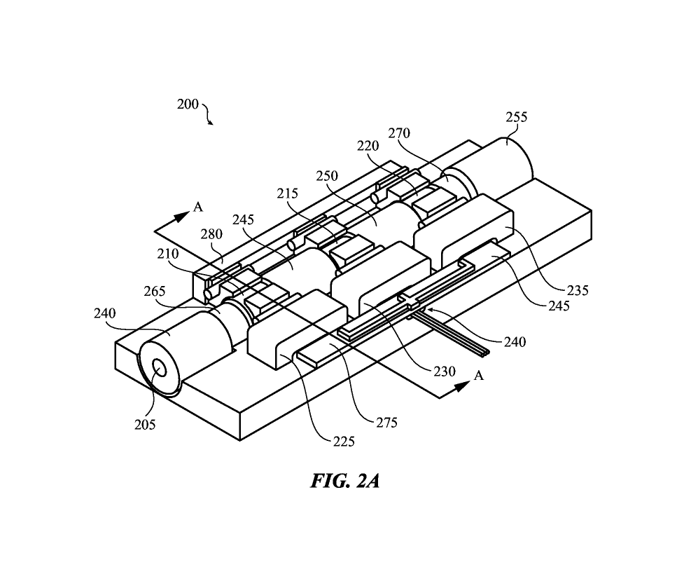

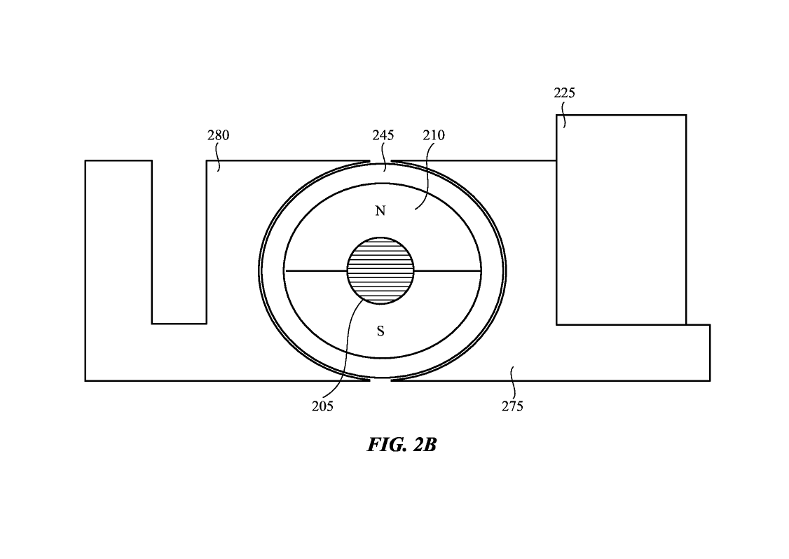

FIG. 2A depicts an isometric view of a first embodiment of a motor 200 powered by time-varying the energization of one or more stators. The embodiment of FIG. 2A includes a central shaft 205 and three magnets 210, 215, 220 encircling the shaft. These first, second and third magnets 210, 215, 220 are affixed to the shaft 205. Accordingly, if the magnets rotate, the shaft rotates and vice versa.

Three stators 225, 230, 235 are connected to an electrical connector that supplies power to the stators. When a stator 225, 230, 235 is energized, it generates a magnetic field. Each stator may be individually energized or multiple stators may be simultaneously energized. In one embodiment, three-phase power may be provided to the stators such that each stator 225, 230, 235 is one of fully energized, partially energized or de-energized. Accordingly, it should be appreciated that a stator need not be entirely powered on or off. Current below a maximum available may be provided to a stator, resulting in the generation of a magnetic field (e.g., magnetic flux) at a lower level.

Continuing with the description of FIG. 2A, multiple masses 240, 245, 250, 255 may also be affixed to the shaft 205. The masses may be placed between the magnets 210, 215, 220, at ends of the magnet array, both, or in other locations. For example, a mass may be connected to one end of the shaft at some distance from the magnets. Generally, the masses also rotate as the shaft 205 rotates. Depending on the structure of the masses and the relative placement and/or positioning of the masses with respect to the shaft, rotating the masses may likewise rotate (or slow rotation of) an electronic device 100 to which the motor is affixed.

Further, although the masses 240, 245, 250, 255 are shown as equally distributed about the shaft (e.g., cylindrical), in alternative embodiments one or more masses may be eccentric. This may be useful to cause a vibration in, or motion of, an electronic device incorporating the motor 200.

The masses may be made of any suitable material. Selection of the material may vary according to the maximum rotational rate of the shaft (as generated by the magnetic interaction of the stators 225, 230, 235 and magnets 210, 215, 220), the desired effect of the motor, weight constraints of the electronic device 100, and so on. In some embodiments, the masses are tungsten.

The shaft 205 may rotate relative to the motor housing 260 due to one or more bearings 265, 270. The bearings 265, 270 may hold the shaft 205 while still permitting it to rotate. Although two bearings 265, 270 are shown, it should be appreciated that more or fewer bearings may be used. Further, the bearings may be of any suitable type; they may be ball bearings, jewel bearings, and so on.

The motor may incorporate one or more flux return elements 275, 280 to complete a flux path from a stator, through an associated magnet, and back to the stator via the flux return elements. These elements 275, 280 may be colloquially referred to as “back irons.” In some embodiments, the back irons may be secured to a housing by one or more pins, screws, affixing mechanisms, and so on.

FIG. 2B depicts a simplified, schematic cross-sectional view of the motor 200 of FIG. 2A, taken along line A-A of FIG. 2A and omitting the base structure/housing shown in FIG. 2A. As shown, the magnet 210 is cylindrical with the shaft 205 passing through the center of the magnet. Further, the magnet 210 has its north and south poles opposing each other along a length of the cylinder. In other words, the upper cross-sectional half-circle (in the view of FIG. 2A) has one polarity while the lower cross-sectional half-circle has an opposing polarity. Accordingly, it should be appreciated that the polarities of the magnets are not at a front and back of the cylindrical magnet, but instead each extends along a length of the magnet.

Further and as noted in FIG. 2B, the back irons 275, 280 do not abut one another. Rather, a small gap exists between the back irons to prevent the flux return path to the stator from omitting the magnet 210. In some embodiments a single back iron may be used. In such an embodiment, a portion of the back iron may be thinned such that the magnetic flux preferentially flows through the magnet instead of along the thinned portion of the back iron.

With reference to both FIGS. 2A and 2B, each of the magnets 210, 215, 220 have the same polar structure as shown in FIG. 2B (e.g., one half-cylinder of each magnet is a first polarity and the second half-cylinder of each magnet is a second polarity). However, each magnet 210, 215, 220 is affixed to the shaft 205 and oriented approximately 120 degrees out of phase with respect to one another. Thus, if the first magnet 210 is considered to have a zero degree rotation (e.g., it is a baseline), then the second magnet 215 may be rotated 120 degrees with respect to the first magnet and the third magnet 220 may be rotated 240 degrees with respect to the first magnet.

In embodiments having more or fewer magnets, the degree of offset may vary accordingly. For example, in an embodiment having four magnets, each magnet may be offset by at least 90 degrees from any other. Essentially, each magnet may be rotationally offset by (360/N) degrees from any other magnet, where N is the number of magnets. It is not necessary that the series of magnets is offset sequentially; the magnets may be arranged in any order.

In addition, it is not required that embodiments offset magnets from one another by (360/N) degrees. While this formula may describe certain embodiments, others may have sets of magnets offset by greater or lesser amounts, or may have multiple magnets that are not offset from one another. Typically, however, there is at least some rotational offset between the poles of at least two magnets in any given embodiment.

Rotationally offsetting the magnets 210, 215, 220 in the aforementioned fashion facilitates the operation of the motor. Since the magnets are not in phase, at any given moment, at least one magnet is positioned so that magnetic flux generated by a stator 225, 230, 235 will cause that magnet to rotate. Accordingly, sequential or other time-varying actuation of the stators 225, 230, 235 may continuously rotate the magnets, thereby continuously rotating the shaft. The sequence of energizing the stators may be determined based on the rotational offset/orientation of the cylindrical magnets. Although the embodiment shown in FIG. 2A includes stators that are sequentially energized and de-energized, it should be appreciated that alternative embodiments may incorporate different stator and/or magnet patterns.

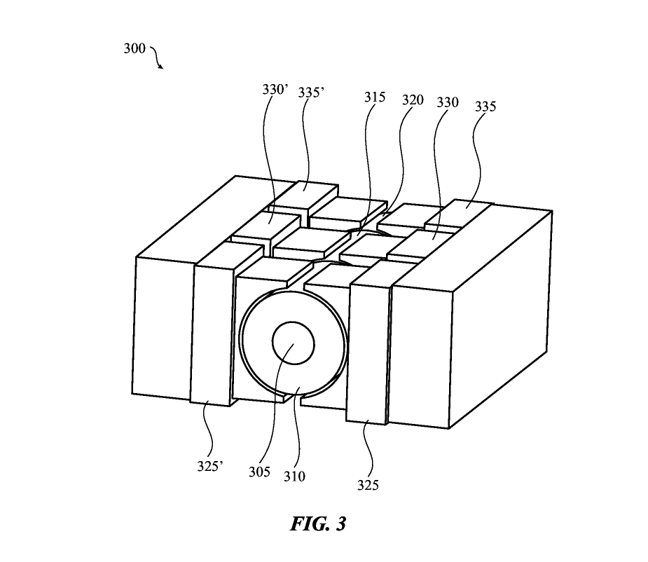

FIG. 3 depicts an isometric view of another sample motor 300 similar to that shown in FIGS. 2A and 2B, having three magnets 310, 315, 320 about a central shaft 305. This embodiment, however, employs six stators 325, 330, 335, 325′, 330′, 335′. Three stators 325, 330, 335 are positioned on a first side of the magnet array and three stators 325′, 330′, 335′ are positioned on a second side of the magnet array. The two stators on opposing sides of the same magnet may form a stator pair.

Each stator pair may be energized simultaneously, thereby generating a magnetic field. When the pair is energized, one stator may have current flowing in a first direction while the second stator of the pair may have current flowing in an opposite direction. Accordingly, the polarization of the generated magnetic field may have a first pole at one stator and an opposing, second pole at the second stator. Thus, the first stator of the stator pair attracts a part of the cylindrical magnet and the second stator of the stator pair repels the same part, and vice versa. In this manner the stator pair exerts both an attractive and repulsive force on the cylindrical magnet positioned between the stators. This may facilitate rotating the cylindrical magnet and thus the shaft. Further, because both attractive and repulsive magnetic forces may be used, the overall rotational speed of the cylindrical magnets and shaft may be greater, or at least more power-efficient to attain, for an embodiment of this type in comparison to an embodiment having only one line of stators as shown in FIGS. 2A & 2B.

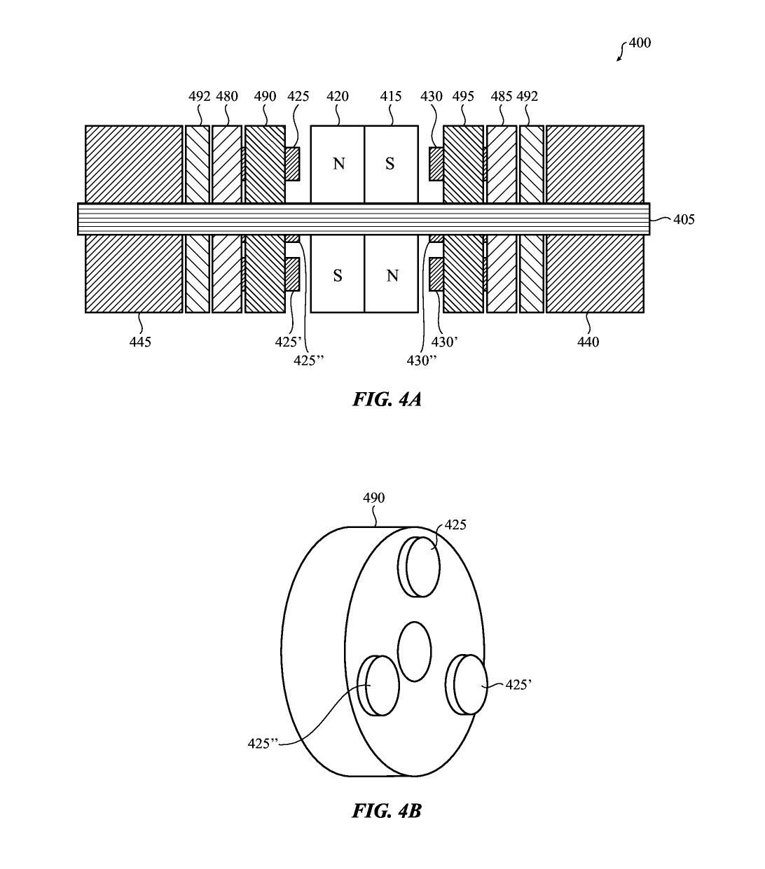

It should be appreciated that the embodiments shown in FIGS. 2A-2B and 3 all are radial flux motors. That is, the field and flux generated by the magnetic elements extends perpendicularly to the longitudinal axis of the shaft (e.g., along a radius of the cylindrical magnet's cross-section). By contrast, the embodiments shown in FIG. 4A-7 are axial flux motors; the magnetic flux extends in a loop along the longitudinal axis of the shaft and the cylindrical magnet or magnets.

FIG. 4A depicts a first cross-sectional view of a sample axial flux magnetic motor 400. The cross-section of the motor 400 is taken through the center of the shaft and other depicted elements. Any housing structures are omitted from this view for purposes of clarity. A housing (not shown) may enclose some or all of the motor 400 and may reduce any diffusion of magnetic flux generated by the motor, as described below. It should be appreciated that any motor described herein may include a housing and that such a housing may serve to contain or otherwise constrain the motor's magnetic flux.

As shown, the shaft 405 extends through a center of a first mass 445, a first back iron 480, a first stator body 490 (which may include and support multiple stators 425, 425′, 425″ extending therefrom, as shown to better effect in FIG. 4B and discussed below), a first magnet 415, a second magnet 420, a second stator body 495 (again, which may include multiple individual stators), a second back iron 485 and a second mass 440. The masses and magnets may be affixed to the shaft, while the back irons and stator bodies typically are not attached to the shaft 405. In this manner, the masses 440, 445 and magnets 415, 420 may rotate with the shaft while the bearings 492, back irons 480, 485 and stator bodies 490, 495 remain stationary. In some embodiments, the stator bodies may be attached to (and rotate with) the shaft while the magnets are stationary. As this is a cross-sectional view, the various elements are shown as rectangular in shape but it should be appreciated that in many embodiments they will be cylindrical in three dimensions. As also shown, the stators, masses, and magnets are all co-axial with the shaft, as is also true for certain other embodiments described herein.

In some embodiments the magnets 415,420 are affixed to one another as well as the shaft. Although the magnets 415, 420 are each sown as complete cylindrical magnets that are bonded or otherwise affixed to one another, each magnet could instead be a half-cylinder and the two may half-cylinders may likewise be affixed to each other. That is, one magnet could form the upper half of the magnetic structure and one the lower half of the structure with respect to the orientation shown in FIG. 4A.

FIG. 4B illustrates an isometric view of a sample stator body 490, showing multiple stators 425, 425′, 425″ extending therefrom. Each of the stators 425, 425′, 425″ may be independently energized or may be energized in conjunction with any other stator, including the stators extending from the second stator body 495.

As with previously-discussed embodiments, sequentially energizing the stators 425, 425′, 425″ generates magnetic flux that may repel one pole of the magnets 415, 420 and attract the other pole. Accordingly, the magnets and affixed shaft may rotate to align themselves with the magnetic flux while the stator bodies 490, 495 and back irons 480, 485 remain stationary. Rotation of the shaft also causes the masses 440, 445 to rotate, which may impart or slow a motion of an associated electronic device, or may generate a haptic or audible output from the device. By varying energization of the stators, the magnetic flux may also be varied and the magnets continually rotated within the flux.

In some embodiments, each stator 425, 425′, 425″ may be paired with, and energized with, a stator 430, 430′, 430″ of the second stator body 495. The paired stators may be located at the same position with respect to their stator bodies (e.g., across from one another) or they may be offset from one another. Generally, any pair or larger group of stators may be co-energized in order to impart motion to the magnets 415, 420 and shaft 405, as desired or necessary.

In the embodiment shown in FIG. 4A, the magnetic flux path generally loops from an energized stator such as stator 425, through the magnets 415, 420, through the second stator body 495 (and optionally another stator extending from the second stator body), into and along a back iron 485, through an opposite end of the second stator body 495, through the lover halves of the magnets 415, 420, through the first stator body 490, into and up the first back iron 480, through the upper half of the stator body 490 and closes the loop at the energized stator 425. The flux path may be reversed depending on the direction of current supplied to the energized stator. Accordingly, the flux path extends along the longitudinal axis of the shaft 405 and thus the motor 400.

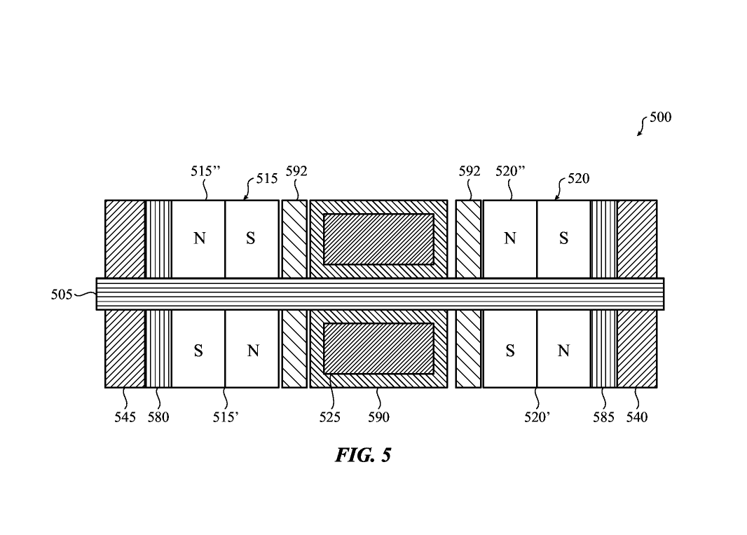

FIG. 5 illustrates a cross-section of another embodiment of an axial-flux motor 500. As with other embodiments, the central shaft 505 extends through a number of structures, including (from left to right in the orientation of FIG. 5) a first mass 545, a first back iron 580, a first set 515 of mated magnets 515′, 515″, a central stator 525 surrounded by a winding 590, a second set 520 of mated magnets 520′, 520″, a second back iron 585 and a second mass 540. The motor 500 of FIG. 5 also may include one or more bearings 592 along the length of the shaft to permit the shaft and certain associated structures to rotate, while others remain stationary. Each pair of magnets in the sets of magnets are typically attached to one another through chemical or mechanical means rather than relying solely on magnetic attraction.

As with other embodiments, some or all of the illustrated structures may be omitted, while other structures may be present. As one non-limiting example, one or both masses 540, 545 may be omitted.

Generally, the motor 500 depicted in FIG. 5 operates in a fashion similar to the motor 400 of FIG. 4A, except that the present motor 500 has a single stator 525. The winding 590 of the stator 525 is shown for illustrative purposes; all stators in the embodiments described herein have some type of winding through which current is passed to generate a magnetic flux.

In the current embodiment, the stator 525 is positioned between the first set of magnets 515 and second set of magnets 520 and is stationary with respect to any revolution of the shaft 505. The magnet sets 515, 520, however, are affixed to the shaft such that the shaft revolves as the magnet sets revolve. Accordingly, when the stator 525 is energized, a magnetic flux is generated that causes the first and second sets of magnets 515, 520 to revolve in order to align their magnetic poles with the flux. If the stator 525 is de-energized then inertia will cause the magnets sets 515, 520 to revolve further. Accordingly, when the stator 525 is re-energized, the magnet sets may continue their revolution to again attempt to align poles with the magnetic flux. As yet another option, current may be passed through the winding 590 in an opposite direction, thereby reversing the flux generated by the stator 525. This may push a magnet that was aligned or near-aligned with the flux generated while current passed through the winding 590 in a first direction, thereby revolving the magnet further.

As discussed with respect to other embodiments, the sets of magnets 515, 520 are typically affixed to the shaft 505 while the stator 525 (and winding 590) is not, but in some embodiments this may be reversed. The back irons 580, 585 may be affixed to the shaft of the motor 500 although that is not necessary. Likewise, the sets of magnets may be attached to the back irons, which in turn may be attached to the masses, although this again is not required and may vary between embodiments.

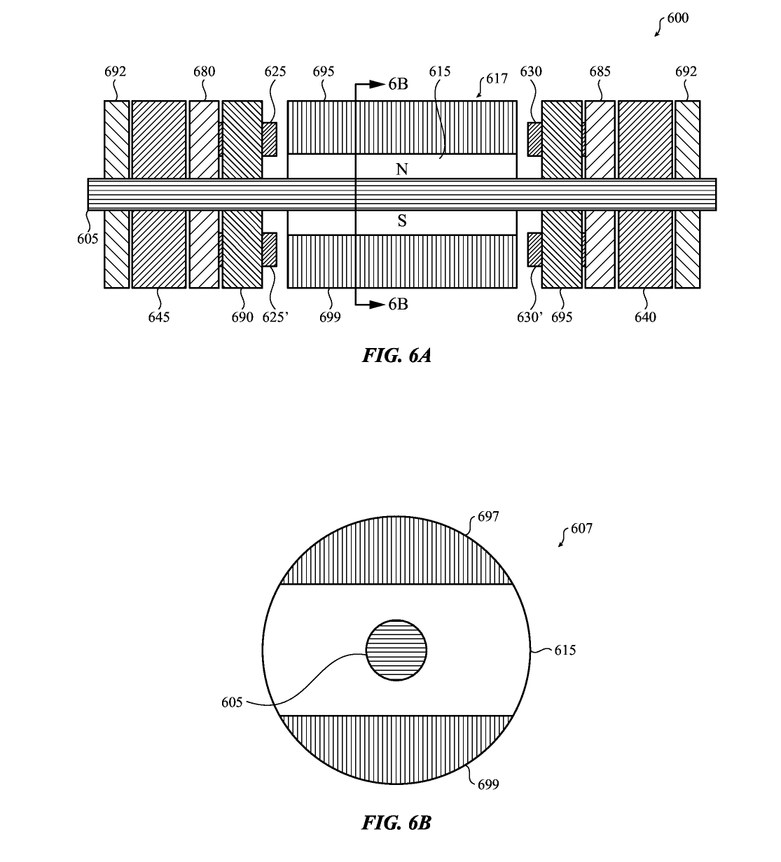

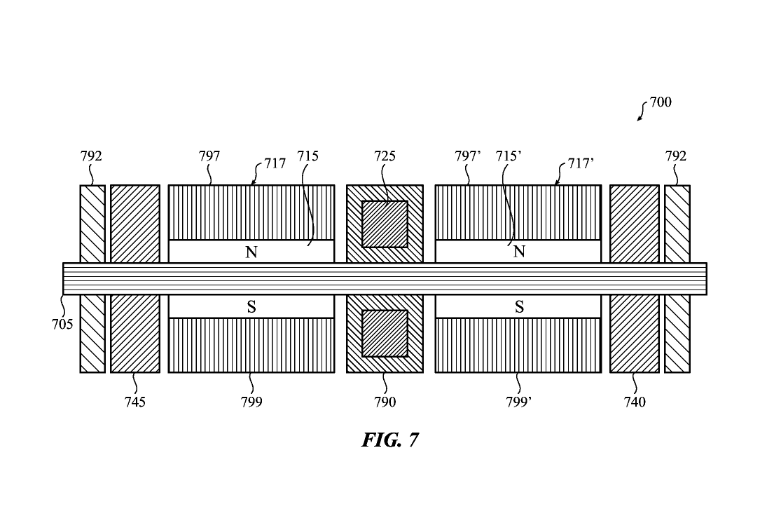

FIG. 6A depicts cross-section of still another embodiment 600 of an axial-flux magnetic motor. The configuration of the motor 600 is generally similar to that shown in FIG. 4A, with masses 640, 645 on either end of the shaft 605 and connect thereto, back irons 680, 685 adjacent or near the masses, stator bodies 690, 695 (and associated stators 625, 625′, 630, 630′) extending from the stator bodies), and a central magnet structure 617 positioned between the stator bodies. Bearings 692 may encircle the shaft to permit the shaft to rotate with respect to a housing (not shown).

Unlike the embodiment of FIG. 4A, however, the central magnetic structure 617 as a single north pole and single south pole. In other words, the central magnet 615 of the structure 617 generally is not a pair of magnets 415, 420 affixed to one another as in the example of FIG. 4A. In addition, the central magnet structure 617 includes not only the aforementioned magnet 615 but also first and second ferritic paths 697, 699. The ferritic paths 697, 699 each form a portion of the cylindrical structure 617 and may also form a portion of the magnetic flux return path for any magnetic field generated by an active stator, as shown in both FIGS. 6A and 6B.

Operation of the embodiment is generally the same as described with respect to previous embodiments.

FIG. 7 illustrates a schematic, cross-sectional view of yet another embodiment 700 of an axial-flux magnetic motor. As with the embodiment of FIG. 5, the motor 700 includes a central stator 725 and associated field winding 790 encircling a shaft 705, as well as a mass 740, 745 positioned at each end of the shaft.

Instead of the first and second sets 515, 520 of mated magnets shown in FIG. 5, however, the present embodiment 700 includes first and second magnetic structures 717, 717′ similar to the central magnetic structure 617 of FIG. 6. Each magnetic structure 717, 717′ is configured similarly to FIG. 6's central magnetic structure 617, including ferritic return paths 797, 799, 797′, 799′ and center magnets 715, 715′. Bearings 792 are located near the ends of the shaft.

Operation of the embodiment 700 shown in FIG. 7 is generally similar to that of the embodiment 500 shown in FIG. 5. In addition, although a single cylindrical stator is shown in FIGS. 5 and 7, two or more stators positioned radially about the respective shafts 505, 705 may be employed instead. In such embodiments, each such stator may have its own winding and may be energized separately or in phase with other radially-positioned stators to move the embodiments' respective magnets, shafts and masses.

It should be noted that the positions of bearings varies between the various embodiments shown in FIGS. 4A-7. The positions of the bearings may change between embodiments and need not be located as shown in any particular figure. Further, the various bearing locations may be used in other embodiments without departing form the spirit or scope of the disclosure.

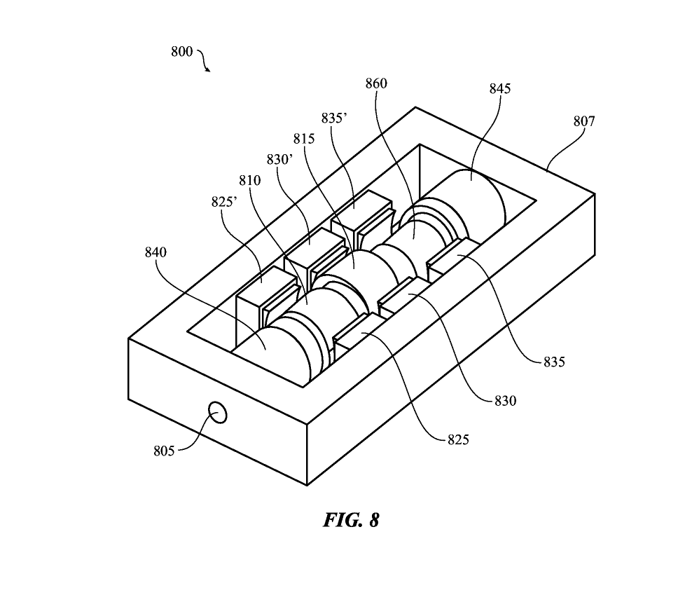

FIG. 8 depicts an isometric view of one embodiment 800 of a magnetic reluctance motor. In this embodiment, ferritic masses 810, 815, 820 encircle and are affixed to the shaft 805 instead of magnets. The ferritic masses 810, 815, 820 may be positioned off-center with respect to the shaft 805 or may be non-cylindrical, such that some portions of each ferritic mass extends closer to an associated stator than another portion of the same ferritic mass. Further, each ferritic mass may be rotationally staggered or otherwise offset with respect to at least one other ferritic mass. In many embodiments, each of the ferritic masses is rotationally offset from all other ferritic masses. As with the aforementioned magnets, the degree of rotational offset between any two ferritic masses may be at least (360/N) degrees, where N is the number of ferritic masses.

As also shown in FIG. 8, three stators 825, 830, 835 are positioned on one side of the ferritic masses 810, 815, 820 and three stators 825′ 830′, 835′ on an opposing side of the ferritic masses. Generally, opposing stators, such as the stators 825, 825′ are concurrently energized to generate a magnetic field. In this fashion, certain portions of each ferritic mass are attracted to an associated stator when the stator is energized such that it generates a magnetic field. By varying the energization of the stators, different ferritic masses may be attracted at different times, thereby rotating the set of masses. As the ferritic masses rotate, so too does the shaft and any other mass or object attached to the shaft.

Put another way, when a stator pair 825, 825′ (or any other stator pair) generates a magnetic field, the off-center or furthest-extending portion of the ferritic mass 810 between the stators of the pair will rotate until that portion is closest to one of the stators 825, 825′. The mass will rotate towards the stator closest to the furthest-extending portion of the mass, thereby reducing reluctance of the system and generating torque.

Once alignment of the first mass 810 is achieved, the first stator pair 825, 825′ may be de-energized. The second stator pair 830, 830′ may then be energized, causing rotation of the second ferritic mass 815 in a similar manner. Once the second ferritic mass is aligned with the second stator pair's magnetic flux, the third stator pair may be energized so that the third ferritic mass likewise rotates.

Insofar as each ferritic mass 810, 815, 820 is affixed to the shaft 805, rotation of any one mass causes rotation of the shaft and the other masses. Thus, by offsetting the protruding portions of each ferritic mass 810, 815, 820, rotation of the prior mass may position the next mass to rotate as discussed above.

With respect to the embodiments described herein, rotation of the magnets and/or ferritic masses is generally out-of-plane with respect to a plane encompassing or parallel to the stators and magnets (or ferritic masses). That is, insofar as the stators and magnets/ferritic masses are coplanar in the embodiments shown in FIGS. 2A, 3, 4A, 5, 6A, 7, and 8, the direction of rotation is always out of that plane. Typically, the direction of rotation is perpendicular to the aforementioned plane; a point on a rotating element may intersect the plane twice during a full rotation or revolution. Accordingly, it should be appreciated that the direction of rotation is likewise perpendicular to a plane in which the magnetic flux circulates. Generally, a longitudinal axis of the shaft is within the plane defined by the position of the magnets and stators, as well.

Embodiments have generally been described herein with respect to particular methods of operation, structures, and elements. However, alternative embodiments may operate in different manners, may omit or add certain structures and/or elements, and/or may include structures and/or elements of different sizes, shapes, and configurations than set forth herein without departing from the spirit or scope of this document. Thus, the embodiments set forth herein are illustrative rather than limiting. Many variations, modifications, additions and improvements are possible. These and other variations, modifications, additions and improvements may fall within the scope of the disclosure and following claims.

We claim:

1. An apparatus, comprising:
a shaft;
a mass disposed on the shaft;
a stator adjacent the shaft; and
a magnet encircling a portion of the shaft; wherein
the stator is configured to generate a magnetic flux;
the magnet is configured to rotate by operation of the magnetic flux on the magnet; and
the stator, mass, and magnet are co-axial with the shaft.

2. The apparatus of claim 1, wherein:
the stator is a first stator; and
further comprising a second stator positioned on an opposite side of the magnet from the first stator.

3. The apparatus of claim 2, further comprising:
a first group of stators that includes the first stator; and
a second group of stators equal in number to the first group of stators; wherein
each of the first group of stators and second group of stators face one another.

4. The apparatus of claim 3, wherein one of the first group of stators is energized simultaneously with one of the second group of stators to generate magnetic flux.

5. The apparatus of claim 4, further comprising:
a group of magnets that includes the magnet, a number of magnets in the group equal to a number of stators in the first group of stators; wherein
each of the magnets in the group of magnets is rotationally offset from at least one other magnet in the group of magnets.

6. The apparatus of claim 5, wherein each of the group of magnets is rotationally offset from all other magnets in the group of magnets.

7. The apparatus of claim 1, further comprising a second magnet encircling the shaft; wherein
the stator is located between the magnet and the second magnet.

8. The apparatus of claim 1, further comprising:
a second stator adjacent the shaft; and
a stator body from which the stator and second stator extend; wherein
the stator body encircles the shaft.

9. The apparatus of claim 8, wherein the magnet comprises:
a first half-cylindrical magnet; and
a second half-cylindrical magnet affixed to the first half-cylindrical magnet.

10. A motor, comprising:
a shaft;
a group of ferritic masses affixed to the shaft;
a group of stators equal in number to the group of ferritic masses, each stator adjacent a ferritic mass of the group of ferritic masses; wherein
each of the group of stators is operative to generate magnetic flux when energized;
each of the group of ferritic masses is operative to rotate perpendicular to a longitudinal axis of the shaft when an adjacent stator is energized, thereby rotating the entire group of ferritic masses and the shaft;
the group of ferritic masses and the group of stators are coplanar; and a longitudinal axis of the shaft is coplanar with the group of ferritic masses and the group of stators.

11. The motor of claim 10, wherein each of the ferritic masses is rotationally offset from one another.

12. The motor of claim 11, wherein a rotational offset between any two of the group of ferritic masses is (360/N) degrees, where N is a number of ferritic masses in the group of ferritic masses.

13. An electronic device, comprising:
a display;
a housing connected to the display;
a motor contained within the housing, the motor comprising:
a shaft;
a mass affixed to the shaft;
a magnetic element encircling the shaft and operative to generate a magnetic field, the magnetic element adjacent the mass; wherein
the mass moves as the magnetic field varies.

14. The electronic device of claim 13, wherein the magnetic element does not rotate.

15. The electronic device of claim 13, wherein the motor is operative to alter a rotation of the electronic device during a drop event.

16. The electronic device of claim 13, wherein the motor is operative to provide a haptic output for the electronic device.

17. The electronic device of claim 13, wherein the magnetic field is perpendicular to an axis of the shaft.

18. The electronic device of claim 13, wherein the shaft passes through the magnetic element and the mass.

19. The electronic device of claim 18, wherein:
the shaft rotates; and
the mass rotates with the shaft.

20. The electronic device of claim 13, further comprising a magnet affixed to the mass; wherein
the magnetic field between the magnet and the magnetic element varies, thereby moving the magnet and the mass.
